(19) United States
(12) Patent Application Publication
(10) Pub. No.: US 2026/0165246 A1
(43) Pub. Date: Jun. 18, 2026

(54) PRODUCE HARVESTER

(71) Applicant: The Regents of the University of California, Oakland, CA (US)

(72) Inventors: Reza Ehsani, Merced, CA (US); Joseph Priester, Merced, CA (US); Cristian Manzo, Merced, CA (US); Mohammadmehdi Maharlooei, Merced, CA (US)

(21) Appl. No.: 19/424,262

(22) Filed: Dec. 18, 2025

Related U.S. Application Data
(60) Provisional application No. 63/735,414, filed on Dec. 18, 2024.

(51) Int. Cl. A01D 46/253; A01D 46/20

(52) U.S. Cl. CPC A01D 46/253; A01D 46/20

(57) ABSTRACT

A produce harvesting device is designed for efficient removal of produce from both upper and lower portions of a plant or tree canopy is disclosed. The produce harvester includes a harvest frame that can be coupled to a vehicle and may be equipped with an upper produce harvesting device and a lower produce harvesting device. The upper harvesting device includes chassis, a main body, a camshaft, a receiver, rods or wands supported on the receiver, a first motor, and a second motor. The chassis supports the main body and the camshaft for independent rotation. The first motor is coupled to the main body to rotate the main body, and the second motor is coupled to the camshaft to rotate the main body. The receivers and the rods are supported on the main body to rotate with the main body. The produce harvesting device may include a controller to control rotation of the main body based upon the linear speed of the vehicle towing the produce harvesting body.

### CROSS-REFERENCE TO RELATED APPLICATIONS

This application claims the benefit of, and priority to, U.S. Provisional Patent Application Ser. No. 63/735,414 filed on Dec. 18, 2024. The entire contents of the foregoing application are incorporated by reference herein.

### TECHNOLOGY FIELD

The technology is generally related to produce harvesters, and more particularly to produce harvesters for removing produce from a plant or tree.

### BACKGROUND

Produce harvesting devices for removing produce from a plant or tree are known. Certain known produce harvesting devices include rotatable spindles that support radially extending fingers. The spindles can be rotated to move the fingers into engagement with limbs of the plant or tree supporting the produce to disengage the produce from the limb. However, these produce harvesting devices are not effective for removing produce from lower willowy branches of a tree. Also, these known devices are highly complex and cannot adapt to tree canopies with different depths. A continuing need exists in the art for a less complex produce harvester that can harvest produce from upper and lower portions of a tree canopy and adapt to tree canopies of different depths.

### SUMMARY

According to one embodiment of the present disclosure, a produce harvester is disclosed. The produce harvester includes a harvest frame, a first dampener, and a second dampener secured to the harvest frame. The produce harvester also includes an upper produce harvesting device including a first mount, a second mount, a spindle, wands, and a first motor, the spindle having a first end portion and a second end portion, the first mount secured to the first end portion of the spindle and the second mount secured to the second end portion of the spindle, the wands supported on and extending radially outward of the spindle, the first motor coupled to the first mount to facilitate rotation of the first mount and the spindle, where rotation of the spindle causes rotation of the wands. The produce harvester also includes first and second mount connectors, the first mount connector coupled to the first mount and supported by the first dampener, and the second mount connector coupled to the second mount and supported by the second dampener, where the first and second dampeners are configured to reduce transfer of vibration from the upper produce harvesting device to the harvest frame.

Implementations of the above embodiment may include one or more of the following features. According to one aspect of the above embodiment, the first and second dampeners may be one of vibration absorbers, rubber mounts, vibration isolators, air springs, or helical isolators. The produce harvester may further include a first counterweight supported on the first mount and a second counterweight supported on the second mount. The produce harvester may also include a first cover shielding the first counterweight and the second cover shielding the second counterweight. The first mount may be removably coupled to the first mount connector and the second mount is removably coupled to the second mount connector. The spindle may support a plurality of discs positioned along a length of the spindle, each of the plurality of discs including receivers that receive the wands to secure the wands to the spindle. Rotation of the rotor moves the bristles. The lower produce harvesting device may be supported on the harvest frame below the upper produce harvesting device. Each of the bristles may be formed from a flexible rod. The rotor may include a plurality of support rods connected by support junctions. The plurality of support rods may include a first plurality of support rods and a second plurality of support rods, where the first plurality of support rods is angularly offset from the second plurality of support rods. Each of the bristles may include a first portion, a bristle receiver, and a support rod receiver, the first portion of each of the bristles is supported on the bristle receiver, and the support rod receiver is supported on one of the first plurality of support rods or the second plurality of support rods. Each of the bristles may further include a second portion that can be selectively coupled to the first portion to extend a length of the bristle. The lower produce harvesting device may include a chassis and frame connectors. The chassis may be secured to the frame connectors and configured to support the rotor and the second motor. The frame connectors may be positioned to be secured to the harvest frame.

According to another embodiment of the present disclosure, a produce harvester is disclosed. The produce harvester includes a harvest frame and an upper produce harvesting device supported on the harvest frame. The upper produce harvesting device may include a spindle, wands, and a first motor, the spindle having a first end portion and a second end portion, the wands supported on and extending radially outward of the spindle, the first motor coupled to the spindle to facilitate rotation of the spindle, where rotation of the spindle causes rotation of the wands. The produce harvester further includes a lower produce harvesting device supported on the harvest frame and including a second motor, a rotor, and bristles engaged with the rotor, the second motor operably engaged with the rotor to rotate the rotor, where rotation of the rotor moves the bristles.

According to a further embodiment of the present disclosure, a produce harvester is disclosed. The produce harvester includes a main body, a camshaft, receivers, rods, and a lifter mechanism. The camshaft extends through the main body, and eccentric cam members are supported on the camshaft. The receivers are pivotably supported on the main body by a pivot member, and the rods are supported on the receivers. The lifter mechanism includes followers, a plate, and links. The followers have a first end engaged with the cam members and a second end secured to the plate. The links have first ends pivotably coupled to the plate and second ends pivotably coupled to the receivers such that rotation of the camshaft causes the plate to move reciprocally upwardly and downwardly to cause the receiver to oscillate back and forth about an axis defined by the pivot member. The produce harvester may include a first motor coupled to the camshaft to rotate the camshaft, and a second motor coupled to the main body to rotate the main body in relation to the camshaft. The lifter mechanism may include a biasing mechanism having a bracket, a guide member, and a biasing member that is positioned between the bracket and the plate to urge the followers into engagement with the cam members. The guide member has a first end secured to the plate and a second end that extends through an opening in the bracket, and the biasing member includes a coil spring that is positioned about the guide member. The produce harvester further includes a chassis that is adapted to be coupled to a vehicle for moving the produce harvesting device at a linear speed in relation to a row of trees. The second motor may operate to rotate the main body at a rotational speed congruent to the linear speed of the vehicle. The chassis may be coupled to the first and second motors and the main body with upper and lower mount connectors and upper and lower mounts. The produce harvester may include upper and lower dampeners positioned between the chassis and the upper and lower mount connectors.

Implementations of the above embodiment may include one or more of the following features. According to one aspect of the above embodiment, the lower produce harvesting frame may be positioned on the harvest frame below the upper produce harvesting device. The spindle may support a plurality of discs positioned along a length of the spindle, each of the plurality of discs including receivers that receive the wands to secure the wands to the spindle. The lower produce harvesting device may be supported on the harvest frame below the upper produce harvesting device.

### BRIEF DESCRIPTION OF DRAWINGS

Various aspects of the disclosure are described herein below with reference to the drawings, wherein:

FIG. 1A is a side perspective view of a produce harvester according to aspects of the disclosure;

FIG. 1B is a side perspective view of an alternate version of the produce harvester shown in FIG. 1;

FIG. 2A is a side perspective view of an upper produce harvesting device and a portion of a harvester frame of the produce harvester shown in FIG. 1;

FIG. 2B is a side perspective view of a portion of the upper produce harvesting device and the portion of a harvester frame shown in FIG. 2A;

FIG. 2C is a top view of a portion of the upper produce harvesting device and the portion of the harvester frame shown in FIG. 2A;

FIG. 2D is a side view of the upper produce harvesting device and the portion of the harvester frame shown in FIG. 2A;

FIG. 2E is a side view of a lower portion of the upper produce harvesting device and the harvester frame shown in FIG. 2A;

FIG. 2F is a perspective view from above of a disc and wands of the upper produce harvesting device and the harvester frame shown in FIG. 2A;

FIG. 3A is side view of a lower produce harvesting device of the produce harvester shown in FIG. 1;

FIG. 3B is a rotor of the lower produce harvesting device shown in FIG. 3A;

FIG. 3C is a side perspective view of a chassis of the lower produce harvesting device shown in FIG. 3A;

FIG. 3D is a side perspective view of a bristle of the lower produce harvesting device shown in FIG. 3A;

FIG. 3E is a side perspective view of a spring base of the lower produce harvesting device shown in FIG. 3A;

FIG. 4A is a side perspective view of the harvester frame of the produce harvester shown in FIG. 1 coupled to a vehicle;

FIG. 4B is a side view of the harvester frame shown in FIG. 4A;

FIG. 5A is a side perspective view of a catchment of the produce harvester shown in FIG. 1 in an open position with a produce catcher removed;

FIG. 5B is a side perspective view of the catchment shown in FIG. 5A in an open position with the produce catcher supported on extenders of the catchment;

FIG. 5C is a side view of the catchment shown in FIG. 5A in a closed position with the produce catcher removed;

FIG. 6 is a side view of the produce harvester shown in FIG. 1 attached to a vehicle;

FIG. 7 is a flowchart illustrating an exemplary method for using the produce harvester shown in FIG. 1;

FIG. 8 is a side perspective view of an alternate version of the upper produce harvesting device;

FIG. 9 is a side perspective view of an upper portion of the produce harvesting device shown in FIG. 8;

FIG. 10 is a side perspective view of a lower portion of the produce harvesting device shown in FIG. 8;

FIG. 11 is a side perspective view of a portion of the main body, the receivers, rods, and a lifter mechanism of the produce harvesting device shown in FIG. 8;

FIG. 12 is an enlarged perspective view of the receivers, rods, and lifter mechanism shown in FIG. 12;

FIG. 13 is a side perspective view of a central portion of the produce harvesting device shown in FIG. 8;

FIG. 14 is a front view of the produce harvesting device shown in FIG. 8;

FIG. 15 is a top view of the produce harvesting device shown in FIG. 8; and

FIG. 16 is a side perspective view the portion of the main body, the receivers, rods, and the lifter mechanism of the produce harvesting device shown in FIG. 8 with an alternate version of the rods according to aspects of the disclosure.

### DETAILED DESCRIPTION

The disclosed device will now be described in detail with reference to the drawings in which like reference numerals designate identical or corresponding elements in each of the several views. However, it is to be understood that the aspects of the disclosure are merely exemplary of the disclosure and may be embodied in various forms. Well known functions or constructions are not described in detail to avoid obscuring the disclosure in unnecessary detail. Therefore, specific structural and functional details disclosed herein are not to be interpreted as limiting, but merely as a basis for the claims and as a representative basis for teaching one skilled in the art to variously employ the disclosure in virtually any appropriately detailed structure. In addition, directional terms such as front, rear, upper, lower, top, bottom, distal, proximal, and similar terms are used to assist in understanding the description and are not intended to limit the disclosure.

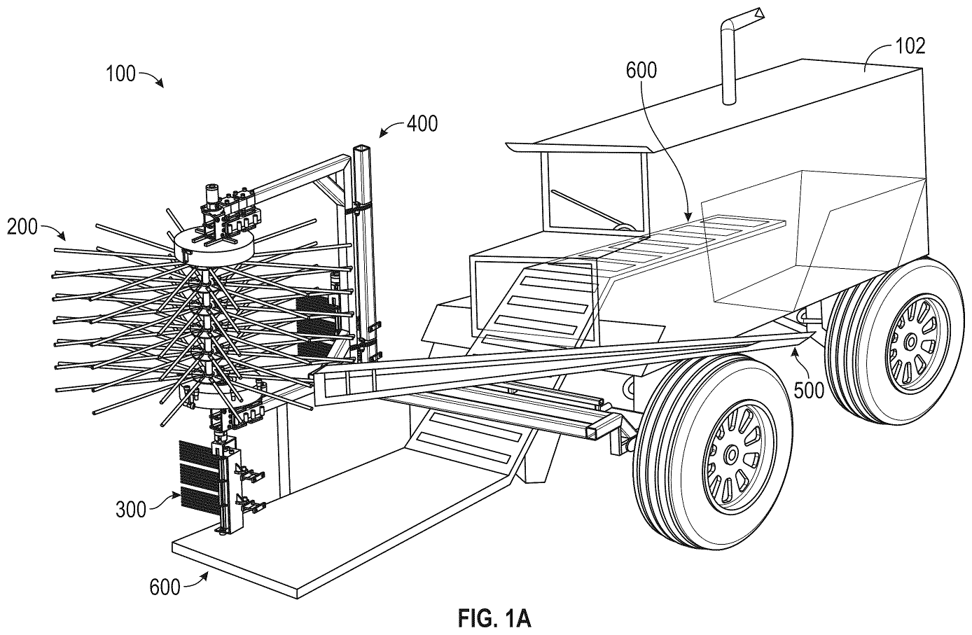

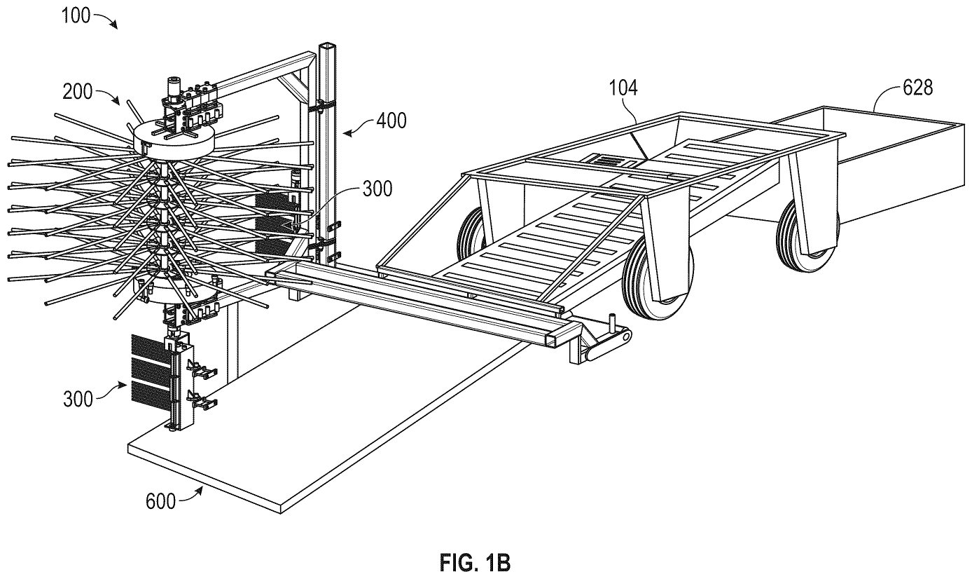

FIGS. 1A-1B illustrate an example embodiment of a produce harvester is shown generally as device 100. Referring to FIG. 1A, the produce harvester 100 may include an upper produce harvesting device 200, a lower produce harvesting device 300, a harvest frame 400, a catchment 500, a transporter system 600, a vehicle 102 (i.e., autonomous, motorized, electric, or any type of vehicles). The produce harvester 100 may be removably coupled to vehicle 102 by any known means via harvest frame 400. In one embodiment, vehicle 102 may be any motorized or electric vehicle, such as a tractor, truck, or any other vehicle capable of collecting and harvesting produce.

In another embodiment, as illustrated in FIG. 1B, the vehicle 104 may be an autonomous, self-driving, computerized vehicle such as a robot or unmanned vehicle. Additionally, more than one lower produce harvesting device 300 may be placed on the produce harvester 100. In another embodiment, the lower produce harvesting device 300 may be positioned at any location desired by the user. For example, lower produce harvesting device 300 may be positioned below the upper produce harvesting device 200. In another example, lower produce harvesting device 300 may be positioned in any desired location between the upper produce harvesting device 200 and vehicle 104 (or vehicle 102 illustrated in FIG. 1A) on harvest frame 400.

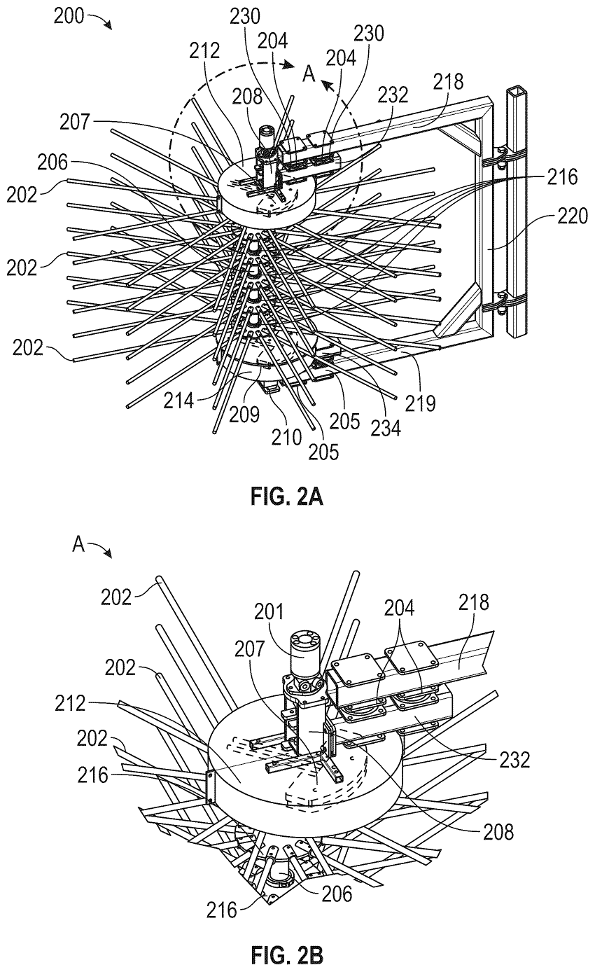

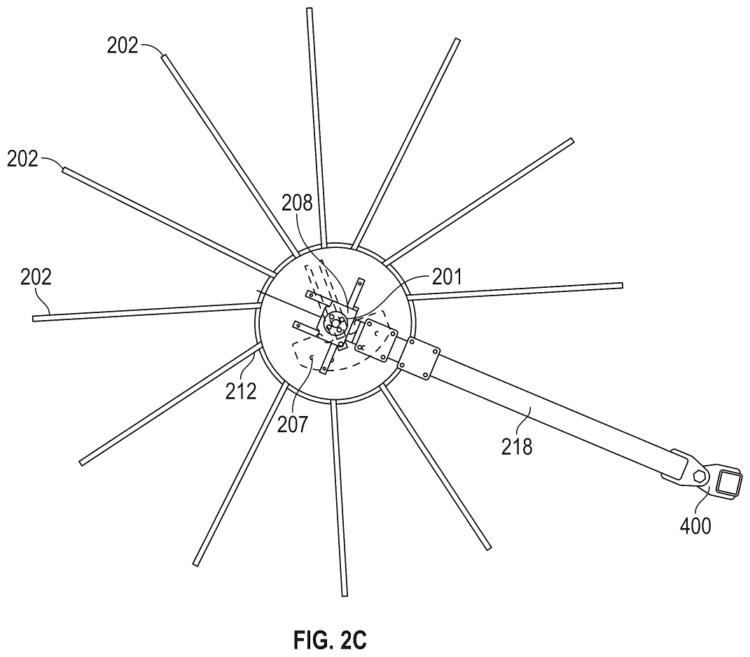

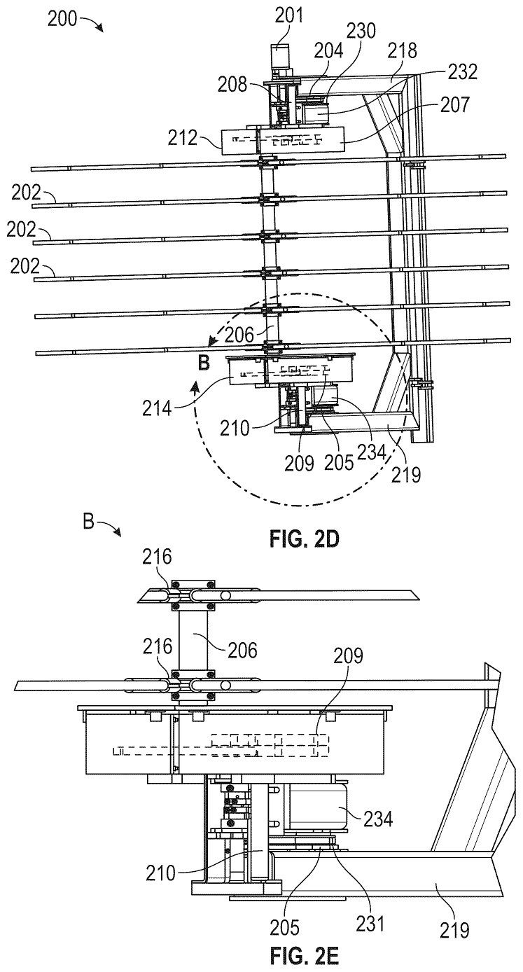

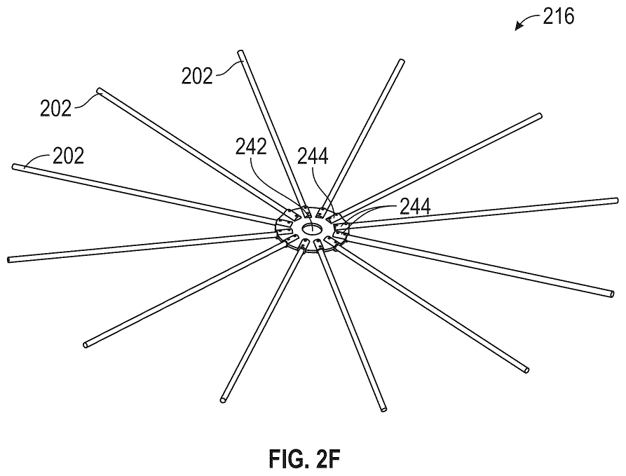

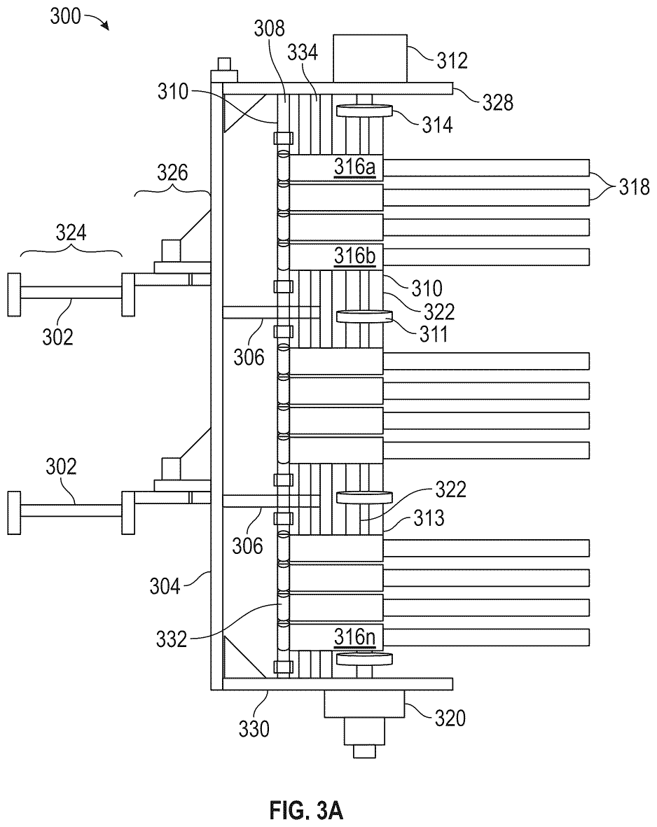

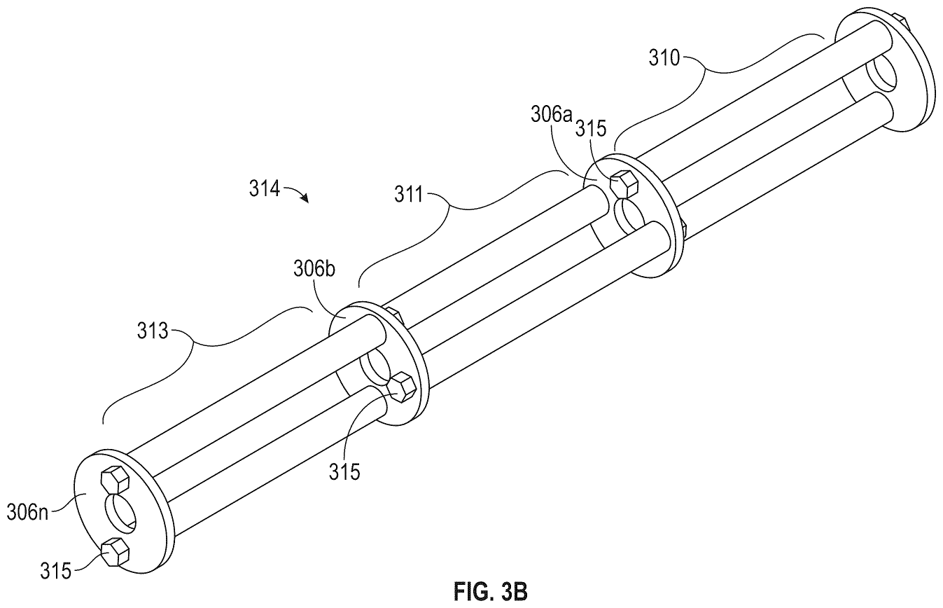

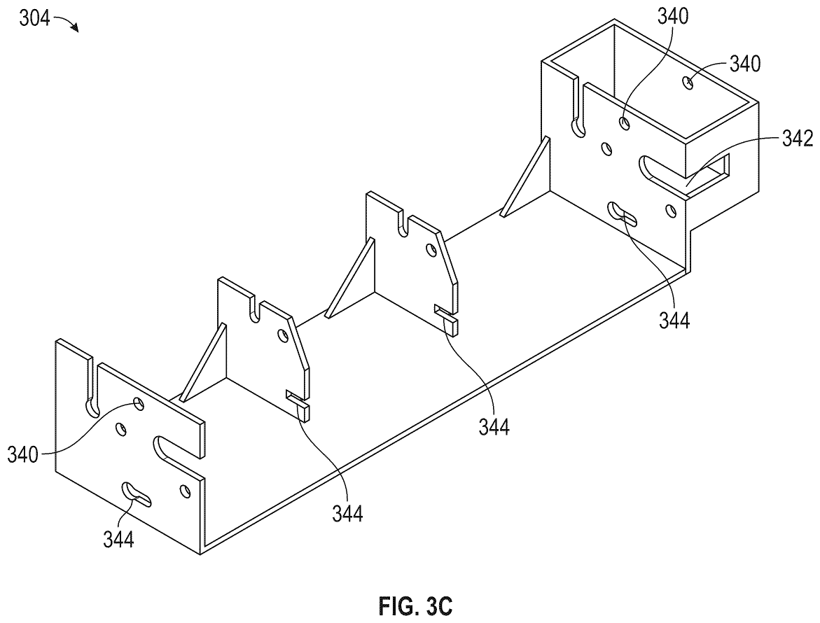

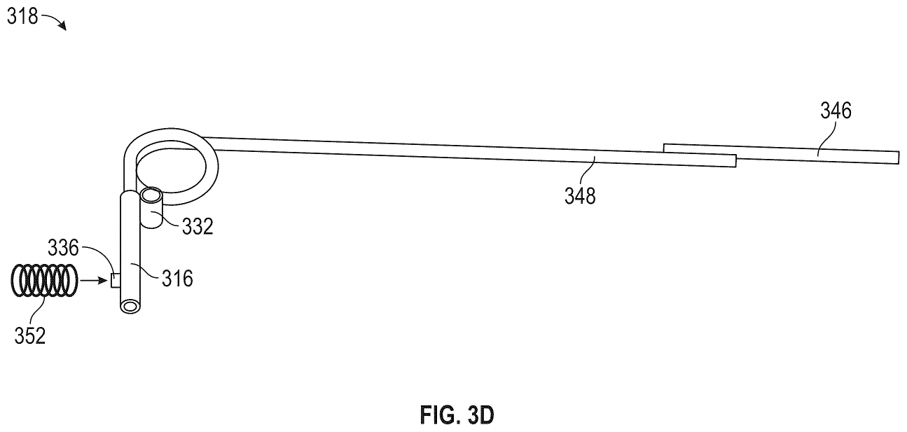

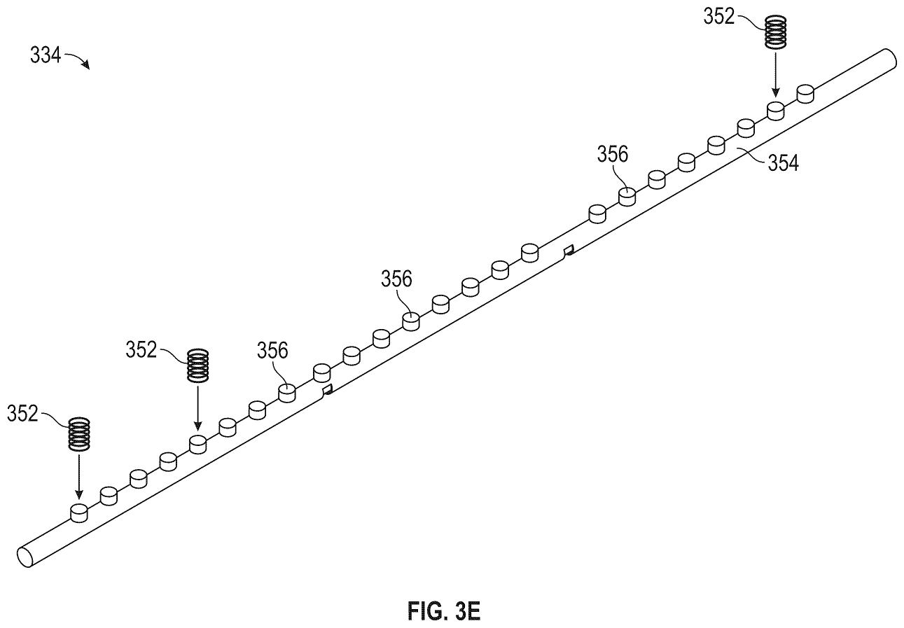

As further illustrated and described in detail below in FIGS. 2A-2F, the upper produce harvesting device 200 may be configured to collect and harvest produce from an upper portion (i.e., canopy) of a tree. As further illustrated and described in detail below in FIGS. 3A-3E, the lower produce harvesting device 300 may be configured to collect and harvest produce from the lower portion (i.e., below the canopy) of a tree. The lower produce harvesting device 300 may be positioned proximate to the upper produce harvesting device 200 or in any other position as desired by the user to harvest produce from the lower portion of a tree. It is also envisioned that the produce harvester 100 may have a variety of different configurations and include one or more upper produce harvesting devices 200 and one or more upper harvesting devices 300 in a variety of different orientations. It is also envisioned that the upper and lower produce harvesting devices can have any desired number of tines, rods, or wands 202.

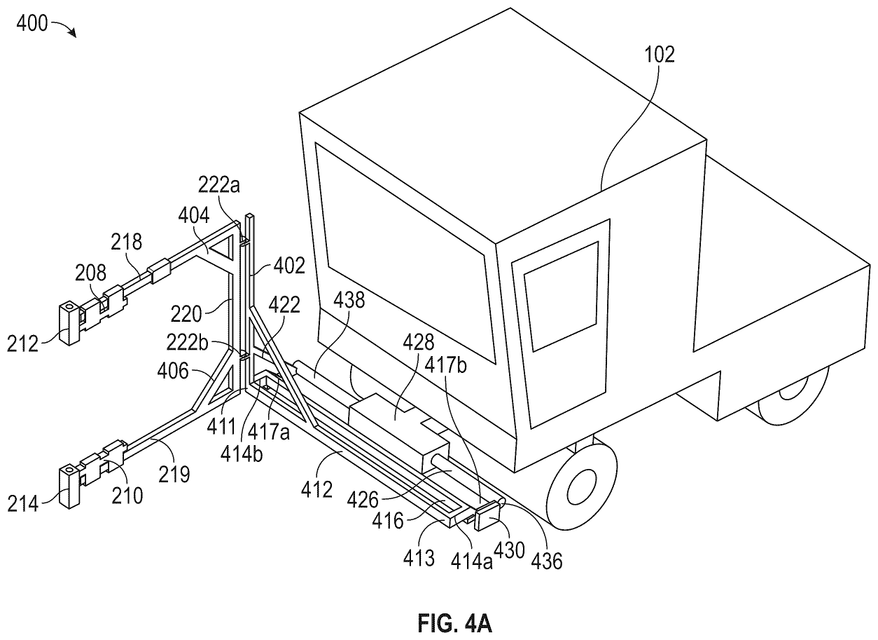

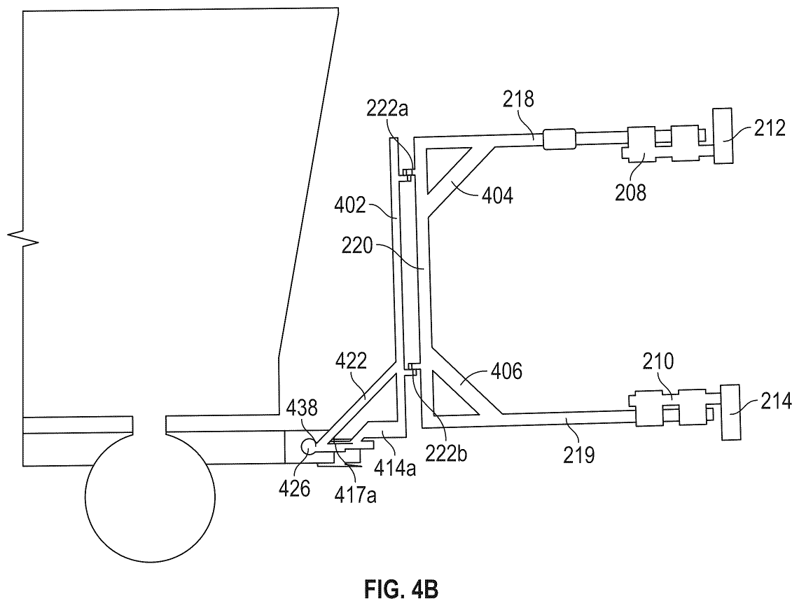

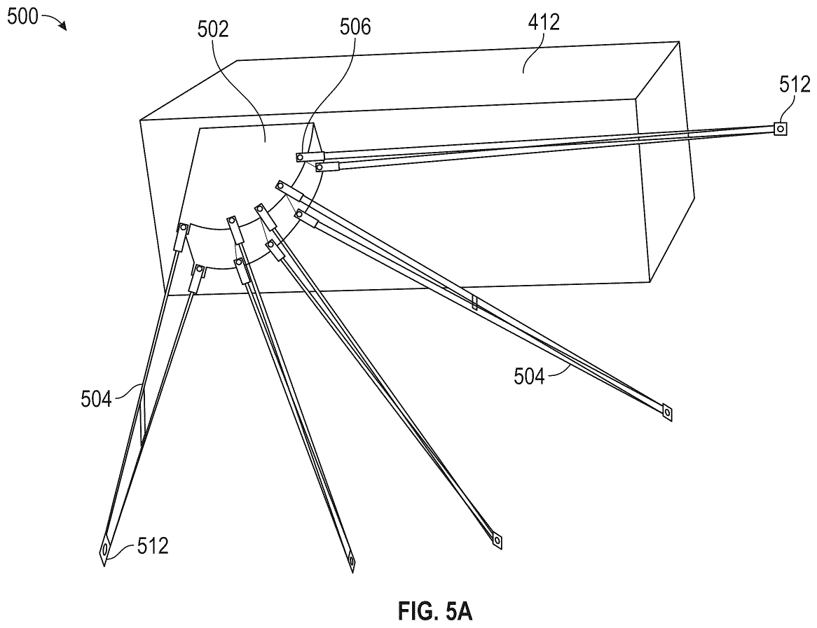

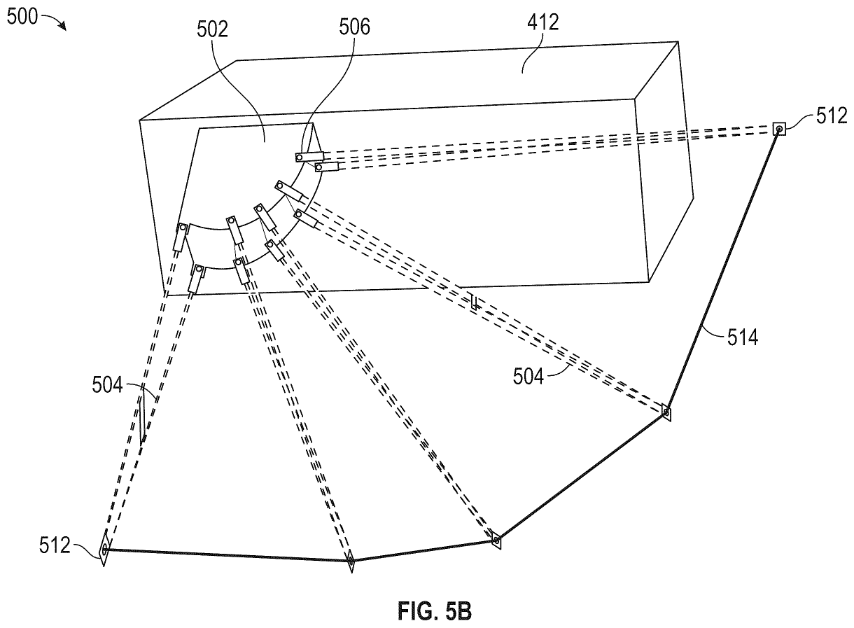

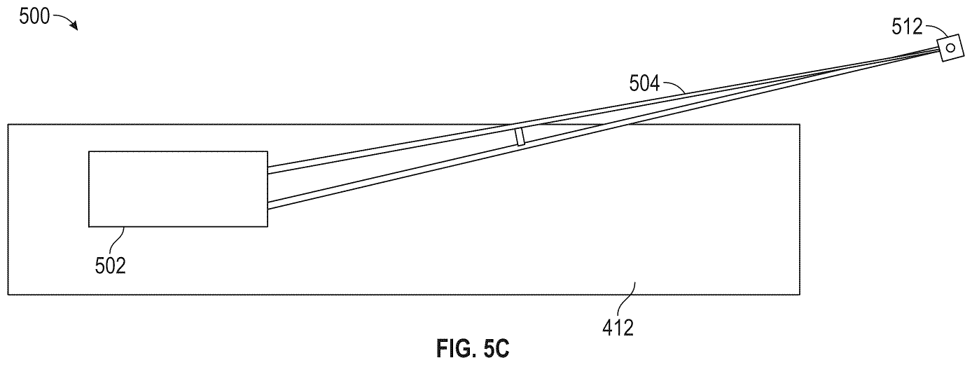

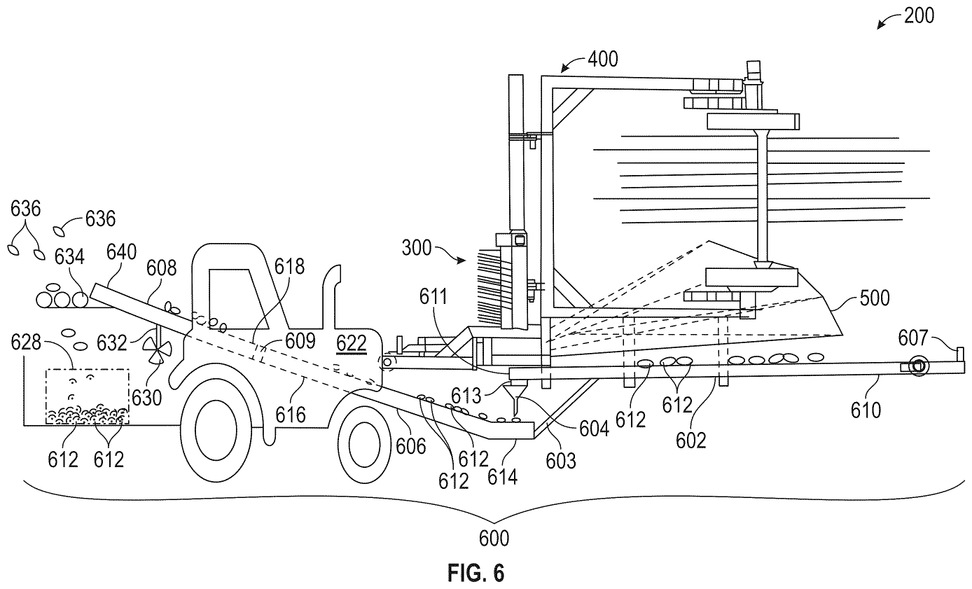

As further illustrated and described in detail below in FIGS. 4A-4B, the harvest frame 400 may serve to connect the upper produce harvesting device 200 (illustrated in FIGS. 2A-2F), lower produce harvesting device 300 (illustrated in FIGS. 3A-3E), a catchment 500 (illustrated in FIGS. 5A-5C), and transporter system 600 (illustrated in FIG. 6) to vehicle 102. Harvest frame 400 may be configured in various shapes, sizes, and attachments. Harvest frame 400 may be configured to withstand various forces, weights, and accommodate other artifacts, small components, or additional additions as desired by the user. The harvest frame 400 may be positioned at the front or back of vehicle 102.

The catchment 500 (as further illustrated and described in detail in FIGS. 5A-5C) may be designed to operate in an open or closed position. In an open position, catchment 500 may be configured to collect produce during harvesting by the upper and lower produce harvesting devices 200, 300. Once the produce is collected and caught by catchment 500, the produce may be transported via transporter system 600 (illustrated and further described in detail in FIG. 6) to a collection container 628.

FIGS. 2A-2F illustrate an example embodiment of an upper produce harvesting device 200. With reference to FIG. 2A, the upper produce harvesting device 200 may be configured to collect and harvest produce from an upper portion (i.e., canopy) of a tree. The upper produce harvesting device 200 includes an upper frame beam 218, a lower frame beam 219, and an intermediate frame beam 220 that connects the upper frame beam 218 to the lower frame beam 219 and defines a space for receiving the upper produce harvesting device 200. The upper frame beam 218 and the lower frame beam 219 may be configured to removably receive and support the upper produce harvesting device 200. The upper frame beam 218, the lower frame beam 219, and the intermediate frame beam 220 may be made from any desired or known materials, such as metals, e.g., steel, aluminum, alloys, thermoplastics, carbon fiber, and the like. The intermediate frame beam 220 may be coupled to the harvest frame 400 as illustrated in FIG. 4 and described in more detail below.

A plurality of top dampeners 204 may be removably coupled to the upper frame beam 218 and a plurality of bottom dampeners 205 may be removably coupled to the lower frame beam 219. Although illustrated with the use of two top dampeners 204 and two bottom dampeners 205, this is not intended to be limiting as any desired number of dampeners may be used. The top dampeners 204 and the bottom dampeners 205 may be any known dampeners such as a vibration absorber, rubber mounts, vibration isolator, air springs, helical isolator, and the like. The top dampeners 204 and bottom dampeners 205 may reduce vibrations and shaking from the upper harvesting device 200 and therefore reduce the transfer of the vibration and shaking to the produce harvester 100.

The top dampeners 204 may have a top dampener inner surface 230 and the bottom dampeners 205 may have a bottom dampener inner surface 231 (illustrated in FIG. 2E). The top dampener inner surface 230 may be configured to receive and support a first mount connector 232 and the bottom dampener inner surface 231 may be configured to receive and support a second mount connector 234. The top dampener inner surface 230 and the bottom dampener inner surface 231 may be made from any desired or known materials, such as steel, aluminum, carbon alloys, and the like. The first mount connector 232 may be configured to removably receive and support a first mount 208 and the second mount connector 234 may be configured to removably receive and support a second mount 210. The first mount connector 232 and the second mount connector 234 may be made from any desired or known materials, such as steel, aluminum, carbon alloys, and the like. It is envisioned that the top and bottom dampeners 204, 205 can be secured to the upper frame beam 218 and the lower frame beam 219 using a variety of different attachment devices or techniques.

In aspects of the disclosure, the first mount 208 may be removably coupled to a first cover 212, which covers and hides a first counterweight 207 coupled to the first mount 208. The second mount 210 may be removably coupled to a second cover 214, which covers and hides a second counterweight 209 coupled to the second mount 210. The second cover 214 and the first cover 212 may be used to protect the users from the first counterweight 207 and second counterweight 209 when in use. The first mount 208, second mount 210, first cover 212, second cover 214, first counterweight 207, and second counterweight 209 may all be made from any desired or known materials, such as steel, aluminum, carbon alloys, and the like.

When in use, the first counterweight 207 and second counterweight 209 may provide stability to the upper produce harvesting device 200 as well as reduce vibrations to the produce harvester 100. A rod or spine 206 may be inserted and secured by the first mount 208 at one end and received and secured by the second mount 210 at a second end. The spine 206 may provide support for a plurality of discs 216 that may be made from any desired or known materials, such as metals, e.g., steel, aluminum, alloys, thermoplastics, carbon fiber, and the like. The plurality of discs 216 may be attached to the spine 206 using pressure clamps, screws, bolts, or any other known methods to join parts to a rod. In another example, the plurality of discs 216 may have an aperture 242 (illustrated in FIG. 2F) to receive the spine 206. Any number of discs 216 may be used as desired by the user.

Each of the plurality of discs 216 may have a plurality of wand receivers 244 (illustrated in FIG. 2F). Each plurality of wand receivers 244 are configured to receive a rod or wand 202 and may use bolts or any other known method of joining parts to secure the wand 202 into the wand receivers 244. The wand 202 may be used to dislodge produce from a plant or tree and may be made with any desired flexible, resilient materials, such as polyethylene, polypropylene, bamboo, polyvinyl chloride, and the like. In one example, the wand may be inflexible and be made of any known materials such as steel, aluminum, copper, or any other metal, and the like. Any number of wands may be used as desired by the user. Additionally, each wand may be of varying length and diameter. For example, the wand may have a length of between one (1) foot and five (5) feet. In another example, the wand may have a length of between 0.5 feet to 8 feet. In another example, the wand may have a length of 2 feet to 6 feet. In yet another example, each wand may have a varied length. In other words, not all wands are the same length.

FIG. 2B illustrates an example embodiment of section A illustrated in FIG. 2A. A plurality of top dampeners 204 may be removably coupled to the upper frame beam 218. The top dampeners 204 may reduce vibrations and shaking from the upper harvesting device 200 and therefore reduce the transfer of the vibration and shaking to the produce harvester 100. The top dampeners 204 may be any known dampeners such as a vibration absorber, rubber mounts, vibration isolator, air springs, helical isolator, and the like. The top dampeners 204 may have a top dampener inner surface 230 and may be configured to receive and support a first mount connector 232. The first mount connector 232 may be configured to removably receive and support a first mount 208.

Motor 201 may be coupled to the first mount 208. The motor 201 may be any known motor such as an electric motor, hydraulic motor, brushless motor, and the like. The motor 201 may rotate the spine 206 and the first counterweight 207 and the second counterweight 209 to move the wands 202 and facilitate harvesting of the produce. In one example, the motor 201 rotates the spine 206 in a circular motion about a vertical axis. In another example, the motor 201 can rotate the spine 206 bi-directionally clockwise and counterclockwise. In use, the wands 202 will pass through a plant or a tree and impact the branches to remove any produce from the plant or tree. As illustrated in FIG. 2D, motor 201 and spine 206 are positioned on different planes or axis. In other words, motor 201 and spine 206 are off axis thereby requiring use of first counterweight 207 and second counterweight 209.

The first mount 208 may be removably coupled to a first cover 212 which covers and hides a first counterweight 207. The first cover 212 may be used to protect users from the spinning first counterweight 207 when in use. The first counterweight 207 may provide stability to the upper produce harvesting device 200 as well as reducing vibrations to the produce harvester 100. The spine 206 may be inserted and secured to the first mount 208 at one end. Spine 206 may be configured to receive a plurality of discs 216.

FIG. 2C illustrates a top view of an example embodiment of the upper produce harvesting device 200 illustrated in FIG. 2A. The upper frame beam 218 is configured to removably receive and support the upper produce harvesting device 200. The upper frame beam 218 may be coupled to the harvest frame 400 as illustrated in FIG. 4.

The first counterweight 207 may provide stability to the upper produce harvesting device 200 and may reduce vibrations to the produce harvester 100 (illustrated in FIG. 1). Spine 206 (illustrated in FIG. 2A-2B) may be inserted and secured to the first mount 208, first cover 212, and plurality of discs 216 illustrated in FIGS. 2A and 2B. First cover 212 may be used to protect a user from the first counterweight 207 when the upper produce harvester 200 is in use. Each of the plurality of discs 216 may have a plurality of wand receivers 244 (illustrated in FIG. 2F). Each plurality of wand receivers 244 are configured to receive a wand 202 and may use bolts or any other known method of joining parts to secure the wand 202 into the wand receivers 244. The wand 202 may be used to dislodge produce from a plant or tree and may be made with any desired or known flexible materials, such as polyethylene, polypropylene, bamboo, polyvinyl chloride, and the like. In one example, the wand 202 may be inflexible and be made of any known materials such as steel, aluminum, copper, metal, and the like. Any number of wands may be used as desired by the user.

FIG. 2D illustrates a side view of an example embodiment of the upper produce harvesting device 200 illustrated in FIG. 2A. Detailed embodiments of the upper produce harvesting device 200 are described above with reference to FIG. 2A. As illustrated, motor 201 and spine 206 are on different planes or axis. In other words, motor 201 and spine 206 are off axis thereby requiring use of first counterweight 207 and second counterweight 209.

FIG. 2E illustrates an example embodiment of section B illustrated in FIG. 2D. A plurality of bottom dampeners 205 may be removably coupled to the lower frame beam 219. The bottom dampeners 205 may reduce vibrations and shaking from the upper harvesting device 200 and therefore reduce the transfer of the vibration and shaking to the produce harvester 100. The bottom dampeners 205 may be any known dampeners such as a vibration absorber, rubber mounts, vibration isolator, air springs, helical isolator, and the like. The bottom dampeners 205 may have a bottom dampener inner surface 231 that may be configured to receive and support a second mount connector 234. The second mount connector 234 may be configured to removably receive and support a second mount 210.

The second mount 210 may be removably coupled to a second cover 214, which covers and hides a second counterweight 209. The second cover 214 may be used to protect users from the spinning second counterweight 209 when in use. The second counterweight 209 may provide stability to the upper produce harvesting device 200 as well as reducing vibrations to the produce harvester 100. The spine 206 may be inserted and secured to the second mount 210 at one end. Spine 206 may be configured to receive a plurality of discs 216.

FIG. 2F illustrates an example embodiment of a disc. The disc 216 includes an aperture 242 in the center to receive the spine 206 illustrated in FIG. 2A. In one embodiment, the disc may be secured to the spine with any known locking mechanism via a bolt, screw, hinge, or any other securing device. In another embodiment, the disc 216 may be welded to the spine 206.

FIGS. 3A-3E illustrate an example embodiment of a lower produce harvesting device 300. With reference to FIG. 3A, the lower produce harvesting device 300 may be configured to collect and harvest produce from the lower portion (i.e., below the canopy) of a tree. As illustrated in FIG. 3A, the lower produce harvesting device 300 may include a plurality of frame connectors 302. Each of the plurality of frame connectors 302 has a first portion 324 and a second portion 326. The first portion 324 of each of the plurality of frame connectors 302 may be removably coupled to the intermediate frame beam 220 (as illustrated in FIG. 4A) by any known means such as with the use of screws, bolts, welding, adhesive, latches, and the like. The second portion 326 of each of the plurality of frame connectors 302 may be removably coupled to a chassis 304 by any known means such as with the use of screws, bolts, welding, adhesive, latches, and the like. The plurality of frame connectors 302 may be coupled to the lower produce harvesting device 300 via the chassis 304 as further described below in FIG. 3C. Although illustrated with two frame connectors 302, this is not intended to be limiting as any desired number of frame connectors may be used to support the lower produce harvesting device 300 to the upper produce harvester 200 and the produce harvester 100. The frame connectors 302 may be made from any desired known materials such as steel, iron, wood, aluminum, and the like.

The lower produce harvesting device 300 may have a rotor 314 configured to rotate about the y axis. Each of the thereby activating the drivers 316a-n potentially causing the drivers 316a-n to move perpendicularly to the main axis of the first, second, and third pluralities of support rods 310, 311, and 313 when the bottom motor 312 presses down on the receivers 316 a-n. The drivers 316a-n may also be configured to move sequentially (i.e., driver 316 a swings, followed by driver 316 b, followed by 316c-n).

FIG. 3B illustrates an example embodiment of a rotor 314. The rotor 314 may consist of a first plurality of support rods 310, a second plurality of support rods 311, and a third plurality of support rods 313. Although described with three sets of pluralities of support rods 310, this is not intended to be limiting, as any known number of support rods may be used as desired by the user. Each of the rods in the first plurality of support rods 310 may be positioned in parallel. Each of the rods in the second plurality of support rods 311 may be positioned in parallel. Each of the rods in the third plurality of support rods 313 may be positioned in parallel.

The first plurality of support rods 310, the second plurality of support rods 311, and the third plurality of support rods 313 may be positioned in a non-congruent manner with respect to each other. In other words, each of the first, second, third plurality of support rods 310, 311, 313 may not be longitudinally aligned with each other. In one embodiment, each of the second plurality of support rods 311 is coupled to the plate junction 306a-n in a different position than the first and third pluralities of support rods 310, 313 such that the second plurality of support rods 311 is offset from the first and third pluralities of support rods 310, 313. The rotor 314 may also include plate junctions 306a-n. The plate junctions 306a-n may be configured to receive each of the rods from the first, second, and third pluralities of support rods 310, 311, 313. Each of the support rods from the first, second, and third pluralities of support rods 310, 311, 313 may be coupled to the plate junctions 306a-n by any known means, such as welding, bolting, and the like, e.g., bolts 315 (FIG. 3B). The plate junctions 306a-n may be made of any known material such as steel, aluminum, carbon, and the like.

FIG. 3C illustrates an example embodiment of a chassis 304. The chassis 304 may be configured to serve as a frame for the lower produce harvesting device 300. The chassis 304 may be removably coupled to the second portion 326 of the plurality of frame connectors 302 (illustrated in FIG. 3A) for attachment to harvest frame 400 illustrated in FIGS. 4A-4B. The chassis 304 may have a plurality of apertures designed to receive and secure rotor 314 (illustrated in FIG. 3B). For example, the bottom bearing aperture 340 may be configured to receive a securing mechanism (i.e., screw, bolt, latch, and the like) to secure the rotor 314 and the bottom motor 312 to the chassis 304. In another example, the rotor aperture 342 may be configured to receive at least one rod from either the first, second, or third plurality of support rods 310, 311, 313 (as described in FIG. 3B). In yet another example, the spring base aperture 344 may be configured to receive and secure the spring base 334 to the chassis 304. The chassis 304 may be designed to have any number of apertures necessary to secure the rotor 314 to the chassis 304.

The bottom motor 312 may be configured to mechanically rotate the rotor 314 about the vertical axis, thereby causing the bristles 318 to swing about the vertical axis. By swinging the bristles 318 about the vertical axis, the bristles 318 may serve to collect produce from the lower portion of a tree (i.e., below the tree's canopy). In one embodiment, the bristles 318 may swing in a semi-circular pattern. The bottom motor 312 may be any known motor such as a hydraulic, electric, or the like that is capable of powering the rotation of the first, second, and third pluralities of support rods 310, 311, and 313. The bottom motor 312 may be removably coupled to the upper arm 328 of the lower produce harvesting device 300 via the bottom bearing aperture 340 by any known means such as with the use of screws, bolts, welding, adhesive, latches, and the like. When activated, the bottom motor 312 may mechanically cause each of the first, second, and third pluralities of supports rods 310, 311, and 313 of the rotor 314 to rotate about the Y axis. A bottom cap 320 may be used to protect a user and secure the lower produce harvesting device 300 to chassis 304. The bottom cap 320 may be secured to the lower arm 330 of the lower produce harvesting device 300 by any known means such as with the use of screws, bolts, welding, adhesive, latches, and the like.

FIG. 3D illustrates an example embodiment of one of the plurality of bristles 318. The bristles 318 may be formed from the same flexible, resilient materials as the wands 202. The bristles 318 may have a first portion 346, a second portion 348, a receiver 316, and a support rod receiver 332. If the user desires to extend bristle 318, the first portion 346 may be coupled to the second portion 348 to extend the length of the bristle 318. The first portion 346 of the bristle 318 may be secured to the second portion 348 of the bristle 318 by any known means such as with the use of screws, welding, adhesive, latches, and/or the like. In one embodiment, each of the plurality of receivers 316a-n (FIG. 3A) may be configured to receive the bristle 318. Any number of bristles may be used as desired by the user. Additionally, each bristle may be of varying length and diameter. For example, the bristle may have a length of between one (1) foot and five (5) feet. In another example, the bristle may have a length of between 0.5 feet to eight (8) feet. In another example, the bristle may have a length of two (2) feet to six (6) feet. In yet another example, each bristle may have a varied length from the other bristles. In other words, not all bristles are the same length. In one embodiment, the bristles may have a diameter of 0.5 inches to two (2) inches. In another embodiment, the bristles may have a diameter of 0.5 inches to four (4) inches.

Each of the plurality of receivers 316a-n may be configured to move perpendicular to the main axis of rotor 314 when bottom motor 312 is activated. In one embodiment, the first, second, and third plurality of rods 310, 311, and 313 (illustrated in FIG. 3B) may be configured to move at different times. In other words, the first plurality of rods 310 may initially rotate about the y-axis, followed by the second plurality of rods 311 after n seconds, and lastly the third plurality of rods 313 may begin to rotate after n seconds, thus potentially allowing the bristles 318 to swing at varying times which may allow for maximal amount of produce to be removed and harvested while potentially minimizing damage to the tree. In another embodiment, the first and third plurality of rods 310 and 313 may swing concurrently about the y-axis, with the second plurality of rods 311 swinging about the y-axis for a predetermined, pre-set or pre-determined period of time (e.g., after n-seconds) after initiation of the first and third plurality of rods 310 and 311. The receiver 316 may comprise a spring receiver 336, which may be configured to receive a spring 352.

Support rod receiver 332 may have an aperture extending through the length of the support rod receiver 332. The aperture may be configured to receive one of the support rods 310, 311, and 313 to secure the bristle 318 to the chassis 304.

FIG. 3E illustrates an example embodiment of spring base 334. The spring base 334 may include a spring rod 354 and a plurality of spring receptors 356 coupled to the spring rod 354. The number of spring receptors 356 may correspond to the number of desired bristles 318 and pair to the spring receivers 336. In use, a spring 352 may be coupled to the spring receptor 356 and the spring receiver 336 (illustrated in FIG. 3D). Spring 352 may prevent each of the plurality of bristles 318 from rotating beyond a desired range of motion. In one example, each of the plurality of bristles 318 may rotate 180 degrees. In another example, each of the plurality of bristles 318 may rotate 260 degrees. The spring base 334 may be removably coupled to the upper arm 328 and the lower arm 330 via the chassis 304 by any known means such as with the use of screws, bolts, welding, adhesive, latches, and the like. Similarly, spring base 334 may be made from any desired known materials such as steel, iron, wood, aluminum, carbon fiber, and the like.

FIGS. 4A-4B illustrate an example embodiment of a produce harvest frame. The harvest frame 400 may serve to connect the upper produce harvesting device 200 (illustrated in FIGS. 2A-2F), lower produce harvesting device 300 (illustrated in FIGS. 3A-3E), and a catchment 500 (as illustrated in FIGS. 5A-5C and described in detail below) with the vehicle 102. The intermediate frame beam 220 of the harvest frame 400 may be attached to a frame spine 402 via a plurality of movable joints 222a and 222b. When in use, the movable joints 222a and 222b allow the intermediate frame beam 220 to rotate about the vertical axis of the frame spine 402. This allows the upper produce harvesting device 200 and the lower produce harvesting device 300 to operate at an angle relative to the vehicle 102 to allow for greater access to harvest the produce, such as from a tree. The harvest frame 400 may also consist of an upper frame beam 218 and lower frame beam 219. For additional support, upper connecting rod 404 and lower connecting rod 406 may be attached to the intermediate frame beam 220 through any known means such as with the use of adhesives, welding, fasteners, joints, any known locking mechanism, spring loaded pins, and any other known methods or devices.

A first mount 208 and a second mount 210 may be used to facilitate attachment of the upper harvesting device 200 to the produce harvest frame 400. The produce harvest frame 400 may be removably attached to the first mount 208 and second mount 210 through any connection methods such as with adhesives, welding, fasteners, joints, any known locking mechanism, spring loaded pins, and any other known methods or devices to removably secure the upper produce harvesting device 200 to the harvest frame 400.

The produce harvest frame 400 may also consist of a connecting bar 426, a frame bar 412, a rear frame bar 416, and a counterweight 430. A connecting device 428 may be affixed to the vehicle 102. The connecting device 428 may have an aperture running therethrough to receive the connecting bar 426. This may allow produce harvest frame 400 to connect vehicle 102. Although described with the use of connecting device 428 and connecting bar 426, this is not intended to be limiting as the harvest frame 400 may be connected to vehicle 102 through any other means or devices as would be known to those of ordinary skill in the art.

The frame bar 412, the rear frame bar 416, and the lower linking bars 414a and 414b may form a rectangular frame 413 for structural support. The rectangular frame 432 may have a rear corner 411 for connection to the frame spine 402. The rectangular frame 413 may be connected to the frame spine 402 through any known means such as adhesives, welding, fasteners, joints, any known locking mechanism, spring loaded pins, and any other known methods or devices.

The connecting bar 426 may have a first surface 436 and a second surface 438. The second surface 438 (FIG. 4A) may connect to the frame spine 402 via the secondary support beam 422, which may run diagonally from the frame spine 402 to the connecting bar 426. The second surface 438 may also connect to a first brace 417a. The first surface 436 may be connected to the second brace 417b. Connection of the connecting bar 426 to the frame spine 402 via support beam 422, first brace 417a and the second brace 417b may provide additional structural support.

The second brace 417b may be affixed to a counterweight 430, which may serve to maintain even weight distribution throughout the produce harvester 100. There may be any desired number of counterweights 430 and the weight of the counterweight(s) 430 may be selected to maintain the balance of the produce harvesting device 400.

The intermediate frame beam 220, upper frame beam 218 and lower frame beam 219, plurality of movable joints 222a and 222b, and frame spine 402 may be made of any known materials in the art, such as carbon alloys, steel, aluminum, and the like.

As illustrated in FIG. 4B, a plurality of brackets (not illustrated) may be used to removably secure the lower produce harvesting device 300 to the produce harvest frame 400 at an outer surface of the intermediate frame beam 220. Any plurality of brackets may be used to removably secure the lower produce harvesting device 300 to the produce harvester 400. The brackets may be any known type of mounting bracket or other mounting device that is known to those of ordinary skill in the art.

FIG. 5A illustrates an example embodiment of a catchment 500. The catchment 500 may be designed to operate in an open position (illustrated in FIGS. 5A-5B) or closed position (illustrated in FIG. 5C) and configured to collect produce during harvesting. The catchment 500 may be coupled to the frame bar 412 via a catchment mount 502. The catchment mount 502 may be coupled to the frame bar 412 using any known methods such as with the use of screws, bolts, adhesives, welding, or the like. The catchment mount 502 may have a plurality of extenders 504 extending outwardly from the catchment mount 502. The plurality of extenders 504 may be coupled to the catchment mount 502 via attachment member 506. Although illustrated as a triangular shape, the plurality of extenders 504 may be any desired shape such as a rectangle, rhombus, and the like.

Attachment member 506 may be any device that secures extenders 504 to catchment mount 502 and allows extenders 504 to swing outwardly. For example, extenders 504 may be screws, hinges, bolts, and the like. In another embodiment, attachment member 506 may be a device that secures or locks extenders 504 in a locked position when rotated in an open position and/or closed position. The plurality of extenders 504 may be configured to rotate or move between a closed position and an open position.

In a closed position as illustrated in FIG. 5C, the plurality of extenders 504 may be positioned proximate to or adjacent to each other and extend beyond the frame bar 412. In an open position (as illustrated in FIGS. 5A and 5B), the plurality of extenders 504 may be fanned out to provide an increased surface area to harvest, catch, or receive the harvested produce.

Referring to FIG. 5B, each plurality of extenders 504 may have a catcher attachment member 512. The catcher attachment member 512 may be configured to receive a detachable produce catcher 514 to collect and contain the harvested produce, as illustrated in FIG. 5B. The removable produce catcher 514 may be made as a sheet or a wire mesh, formed from metal, polyamide, polyester, any fabric material, plastic, and the like. The produce catcher 514 may be coupled to the catcher attachment member 512 using any known attachment means such as a screw, hook and loop fastener, hooks, adhesives, zip ties, cable ties, rope, or the like.

FIG. 5B illustrates an example embodiment of the catchment 500 in an open configuration. In an open configuration, the plurality of extenders 504 may expand outward to create an expanded surface area to catch or receive the harvested produce. FIG. 5C illustrates an example embodiment of the catchment 500 in a closed position. In a closed position, each of the plurality of extenders 504 may be positioned proximate the frame bar 412. The catchment 500 may be held in place to the frame bar 412 by any known means such as a lock, chain, spring hinge, clip, (not illustrated) or the like.

FIG. 6 illustrates an example embodiment of a produce transporter system 600. The produce transporter system 600 may be removably coupled to the produce harvester 100 illustrated in FIG. 1A. The produce transporter system 600 may include a first transporter 602, a funnel 604, a second transporter 606, and a third transporter 608. The first transporter 602, second transporter 606, and third transporter 608 are configured to receive produce 612 that is harvested from a plant or tree using the upper produce harvesting device 200 (illustrated in FIG. 2A) and the lower produce harvesting device 300 (illustrated in FIG. 3A). Although illustrated with the use of three produce transporters 602, 606, 608, this is not intended to be limiting as any desired number of produce transporters may be used. For example, the second transporter 606 and third transporter 608 can both be combined into a single transporter.

The first transporter 602, second transporter 606, and the third transporter 608 may be any device capable of moving produce from one location to another. For example, the first transporter 602, second transporter 606, and third transporter 608 may be any known conveyor belts such as an electric conveyer belt. Additionally, the conveyor belt may be any desired shape, such as in an “L” shape configuration as illustrated with the second transporter 606. Furthermore, first transporter 602, second transporter 606, and the third transporter 608 may be any length and width as desired by the user to catch the produce that is being harvested.

The first transporter 602 may have a front side 610 and a back side opposite the front side 610. The back side may be positioned adjacent to or below the catchment 500 (as illustrated and described in FIGS. 5A and 5B) to receive the produce 612 collected by the catchment 500. In one embodiment, the catchment 500 may be positioned above the first transporter 602. The first transporter 602 may also have an end cap 607 to prevent any produce 612 from falling to the ground. The first transporter 602 may be removably coupled to the lower frame beam 219 and may be configured to move when the upper harvesting device 200 and the lower harvesting device 300 are activated.

Once produce 612 is received on the first transporter 602, the produce 612 may be transferred and moved to funnel 604, positioned at a first edge 611 of the first transporter 602. Funnel 604 may be positioned adjacent to and below the first edge 611 of the first transporter 602. The funnel 604 may be formed by any desired or known materials such as stainless steel, plastic, aluminum, and the like. Funnel 604 can be configured to receive the harvested produce 612 by providing a more controlled descent onto the second transporter 606 from the first transporter 602 thereby reducing bruising or damage to the produce 612. The funnel 604 also prevents spillage of the produce 612 onto the ground. Funnel 604 may be coupled to the first transporter 602 through any known means, such as via funnel connectors 613. However, funnel 604 may be coupled to the first transporter 602 through any desired means such as with the use of screws, brackets, hinges, welding, or the like. The length and width of funnel 604 may be any desired length and width that is able to receive the produce 612 from the first transporter 602 for careful placement of the produce 612 onto the second transporter 606 to prevent bruising and minimize spillage of produce 612 onto the second transporter 606. The second transporter 606 may receive the produce 612 collected by the funnel 604 at a second edge 614. The second transporter 606 may be positioned below the funnel 604 to receive the produce 612. The produce 612 may then be carried or transported to a third end 616 of the second transporter 606 that may be internal or positioned within the vehicle 622. In one embodiment, second transporter 606 may be coupled to first transporter 602 via any known methods such as with the use of brackets 603. In another embodiment, second transporter 606 may be securely coupled to the harvest frame 400 of the produce harvester 100 (illustrated in FIG. 1A) via any known methods such as with the use of brackets, hinges, screws, bolts, welding, or the like.

Third transporter 608 may be positioned adjacent to third edge 616 of the second transporter 606 and connected via a transporter connector 609. Third transporter 608 may be securely coupled to the vehicle 622 via any knowns such as with the use of brackets, hinges, screws, bolts, welding, or the like. Produce 612 may be transported from the second transporter 606 to the third transporter 608 to be collected in container 628. Container 628 may be positioned in any location within vehicle 622. For example, container 628 may be positioned at the rear of the vehicle 622, on a trailer (not shown) towed by vehicle 622, or in any other desired location.

Container 628 may collect, and store harvested produce 612. The container 628 may be formed by any desired or known materials such as steel, plastic, wood, or the like. A plurality of brushes 634 may be positioned adjacent to and below the fifth edge 640 of the third transporter 608 and directly above the container 628. The plurality of brushes 634 may be configured to rotate in a circular motion to remove larger debris, such as sticks, leaves, and the like. The plurality of brushes 634 may be configured to have space between each brush to allow for the produce 612 and smaller debris to fall between the plurality of brushes 634 and into the container 628. A blower 630 may be supported on a shaft 632 positioned below the third transporter 608 and adjacent to the container 628 and may be configured to remove smaller and lighter debris such as leaves 636 that fall through the plurality of brushes 634. The blower 630 can be any type of blower, such as an AC blower fan, DC blower fan, centrifugal blower fan, and the like.

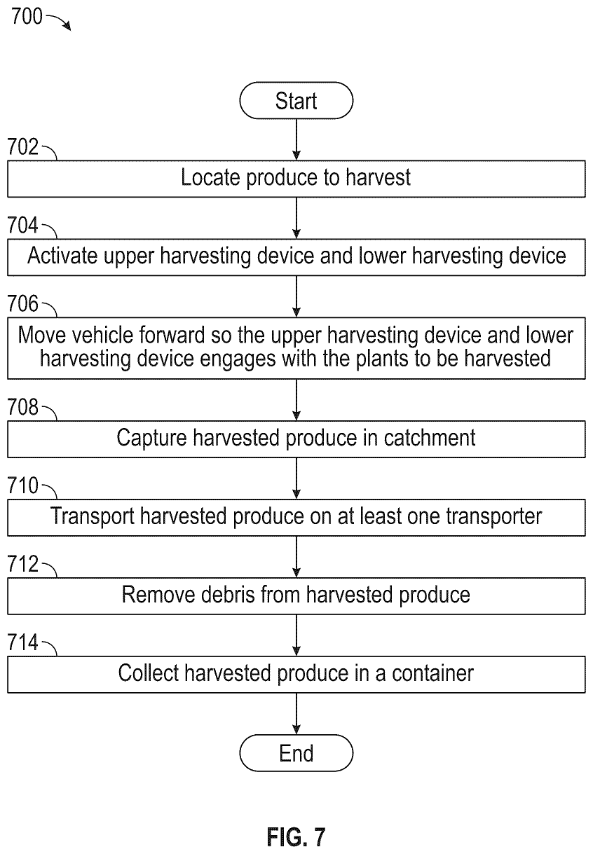

FIG. 7 is a flowchart illustrating an example method 700 to collect harvested produce. The method for collecting harvested produce may begin with locating produce to harvest at step 702. The produce may be located at a nut orchard, an olive orchard, a garden, a farm, or any other such place where produce may be found and harvested. The produce may be identified manually by a person and/or by a computing device and one or more cameras or other sensors attached to the vehicle 102, utilizing computer vision, artificial intelligence, or any other known method of identifying produce.

The upper produce harvesting device (e.g. upper produce harvesting device 200 illustrated in FIG. 1A) and lower produce harvesting device (e.g. lower produce harvesting device 300 illustrated in FIG. 1A) may be activated at step 704 via a motor (e.g., motor 201 illustrated in FIG. 2A) and a bottom motor (e.g., bottom motor 312 illustrated in FIG. 3A). The motor and lower motor may be programmed and/or configured to exert greater or lesser rotational force on the upper produce harvesting device and lower produce harvesting device depending on the type of produce being harvested. For example, when harvesting olives a greater rotational force may be required to remove the olive fruit from the olive tree, whereas harvesting cherries may require less rotational force. The vehicle may be moved for the upper produce harvesting device and lower produce harvesting device to engage with the plant(s) to be harvested at step 706. In one example embodiment, the vehicle (e.g., vehicle 102 illustrated in FIG. 1A) may move autonomously, via cameras, machine learning, artificial intelligence, or any other similar method. In another embodiment, the vehicle may be moved via remote control, via wireless communication protocols, GPS navigation systems, and the like. In yet another embodiment the vehicle may be moved by a person driving and controlling the vehicle. When the upper and lowering produce harvesting devices align with the plant(s) to be harvested, the rotational force exhibited by the upper and lower produce harvesting devices may cause produce to be removed from the plant.

The harvested produce may be captured by a catchment (e.g., catchment 500 illustrated in FIGS. 5A-5B) at step 708. The catchment may be positioned in an open configuration when the upper and lower produce harvesting devices are engaged, which may allow the catchment to catch falling produce harvested by the upper and lower produce harvesting devices. The catchment may be electronically, manually, or mechanically positioned in the open configuration and/or closed configuration.

The harvested produce may be transported on at least one transporter at step 710. The transporter (e.g., transporter 602 illustrated in FIG. 6) may be positioned proximate to the catchment to facilitate movement of the produce to a container (e.g., container 628 illustrated in FIG. 6). As described and illustrated above in FIG. 6, a produce transporter system may include a first transporter 602, a funnel 604, a second transporter 606, and a third transporter 608. The first transporter 602, second transporter 606, and third transporter 608 are configured to receive produce that is harvested from a plant or tree using the upper produce harvesting device 200 (illustrated in FIG. 2A) and the lower produce harvesting device 300 (illustrated in FIG. 3A). Although illustrated with the use of three produce transporters this is not intended to be limiting as any desired number of produce transporters may be used. For example, the second transporter 606 and third transporter 608 can both be combined into a single transporter.

The first transporter 602, second transporter 606, and the third transporter 608 may be any device capable of moving produce from one location to another. For example, the first transporter 602, second transporter 606, and third transporter 608 may be any known conveyor belts such as an electric conveyer belt. Additionally, the conveyor belt may be any desired shape, such as in an “L” shape configuration as illustrated with the second transporter 606. Furthermore, first transporter 602, second transporter 606, and the third transporter 608 may be any length and width as desired by the user to catch the produced that is being harvested.

The first transporter 602 may have a front side and a back side opposite the front side. The back side may be positioned adjacent to or below the catchment 500 (as illustrated and described in FIG. 5A) to receive the produce collected by the catchment 500. In one embodiment, the catchment 500 may be positioned above the first transporter 602. The first transporter 602 may also have an end cap 607 to prevent any produce from falling to the ground. The first transporter 602 may be removably coupled to the lower frame beam and may be configured to move when the upper produce harvesting device 200 and the lower produce harvesting device 300 are activated.

Once produce is received on the first transporter 602, the produce may be transferred and moved to funnel 604, positioned at a first edge of the first transporter 602. Funnel 604 may be positioned adjacent to and below the first edge of the first transporter 602. The funnel 604 may be formed by any desired or known materials such as stainless steel, plastic, aluminum, and the like. Funnel 604 can be configured to receive the harvested produce by providing a more controlled descent onto the second transporter 606 from the first transporter 602 thereby reducing bruising or damage to the produce. The funnel 604 also prevents spillage of the produce onto the ground. Funnel 604 may be coupled to the first transporter 602 through any known means, such as via funnel connectors. However, funnel 604 may be coupled to the first transporter 602 through any desired means such as through the use of screws, brackets, hinges, welding, or the like. The length and width of funnel 604 may be any desired length and width that is able to receive the produce from the first transporter 602 for careful placement of the produce onto the second transporter 606 to prevent bruising and minimize spillage of produce onto the second transporter 606. The second transporter 606 may receive the produce collected by the funnel 604 at a second edge. The second transporter 606 may be positioned below the funnel 604 to receive the produce. The produce may then be carried or transported to a third end of the second transporter 606. The third end may be internal or positioned within the vehicle 622. In one embodiment, second transporter may be coupled to first transporter via any known methods such as the use of brackets. In another embodiment, second transporter may be securely coupled to the frame of the produce harvester system (illustrated in FIG. 1A) via any known methods such as the use of brackets, hinges, screws, bolts, welding, and the like.

Third transporter 608 may be positioned adjacent to third edge of the second transporter 606 and connected via a transporter connector. Third transporter 608 may be securely coupled to the vehicle 622 via any knowns such as the use of brackets, hinges, screws, bolts, welding, or the like.

Debris may be removed from the harvested produce at step 712. As illustrated in FIG. 6, a plurality of brushes 634 may be positioned adjacent to and/or below the fifth edge of the third transporter 608 and directly above the container 628. The plurality of brushes 634 may be configured to rotate in a circular motion to remove larger debris, such as sticks, leaves, and the like. The plurality of brushes 634 may be configured to have space between each brush to allow for the produce and smaller debris to fall between the plurality of brushes 634 and into a container 628. A blower 630 may be positioned below the third transporter to remove smaller and lighter debris such as leaves, soil, and the like that fall through the plurality of brushes 634. The blower 630 can be any type of blower 630, such as an AC blower fan, DC blower fan, centrifugal blower fan, and the like.

The harvested produce may be collected in a container at step 714. With reference to FIG. 6, container 628 may be positioned in any location within the vehicle 622. For example, container 628 may be positioned at the rear of the vehicle 622, on a trailer (not shown) towed by the vehicle 622, or in any other desired location. Container may collect and store harvested produce.

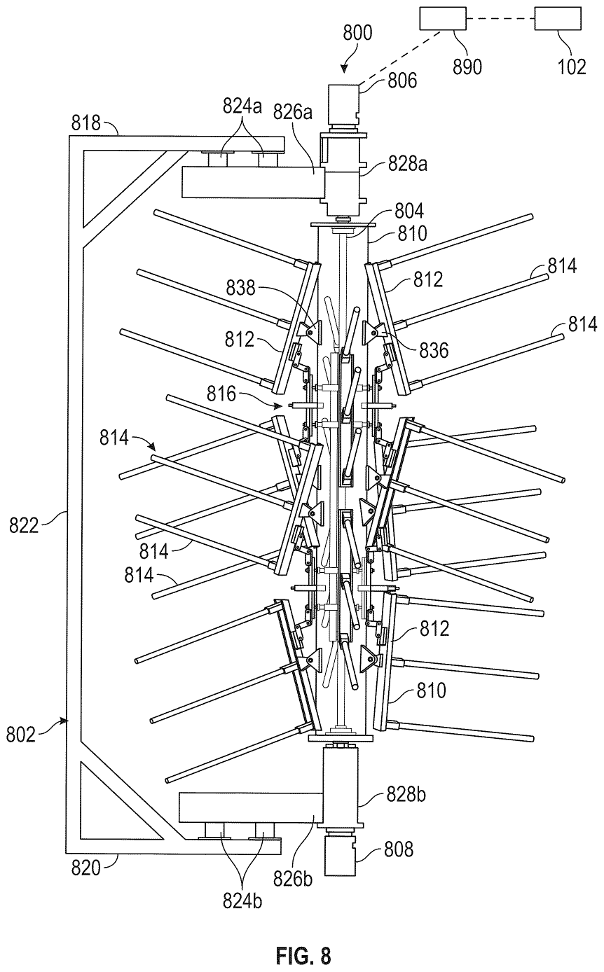

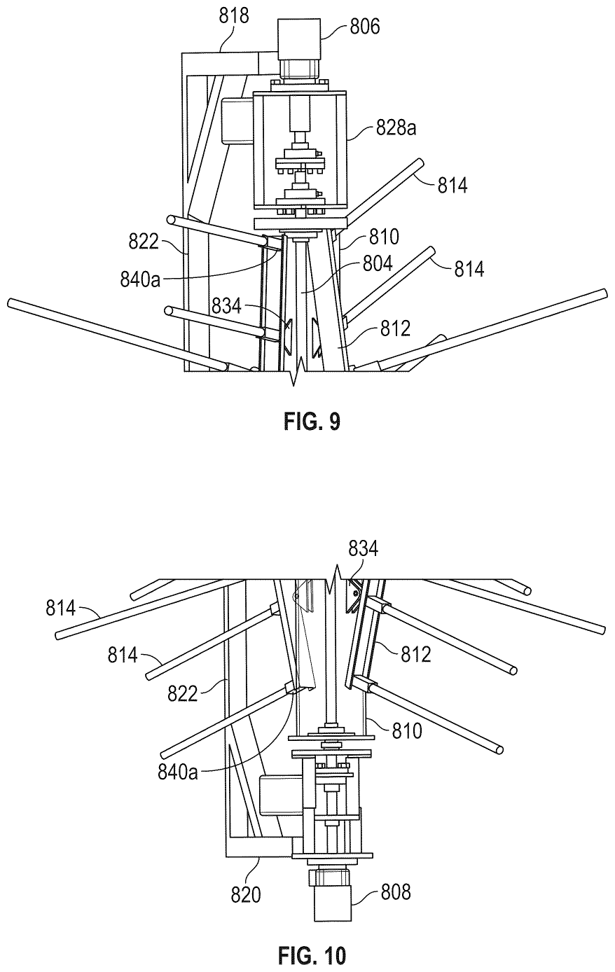

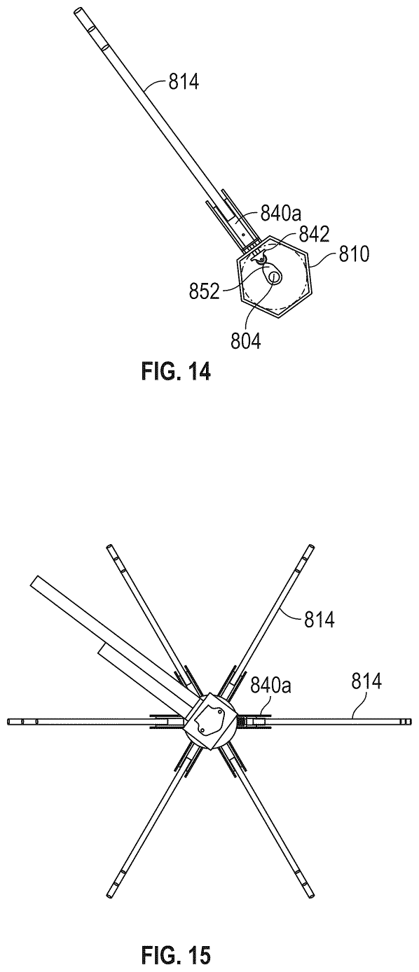

FIGS. 8-15 illustrate an alternate version of the upper produce harvesting device shown generally as produce harvesting device 800. Produce harvesting device 800 includes a chassis 802, a camshaft 804, a first motor 806, a second motor 808, a main body 810, receivers 812, bristles or rods 814, and lifter mechanisms 816. The chassis 802 includes an upper arm 818, a lower arm 820, and an intermediate arm 822 that connects the upper arm 818 to the lower arm 820. The chassis 802 may support a frame connector (not shown) like frame connectors 302 (FIG. 3A) to facilitate coupling the harvesting device 800 to the harvest frame 402 (FIG. 4B) or other support structure. In some aspects of the disclosure, the upper arm 818 and the lower arm 820 of the chassis 802 are coupled to the remaining components of the produce harvesting device 800 by upper and lower dampeners 824a and 824b, upper and lower mount connectors 826a and 826b, and upper and lower mounts 828a and 828b like the dampeners 204, mount connectors 232, and mounts 208 (FIG. 2A) described above.

The first motor 806 is supported on the upper mount 828a and the second motor 808 is supported on the lower mount 828b. The camshaft 804 extends through the main body 810 into the lower mount 828b and is coupled to the motor 808 and defines a longitudinal axis “Y”. The main body 810 is rotatably supported by the camshaft 804 and is driven in rotation independently of the camshaft 804 by the first motor 806. In aspects of the disclosure, the rotational speed of the main body 810 is selected to be congruent to the linear velocity of the produce harvesting device 800, i.e., the speed of the vehicle 102 (FIG. 4A), to allow the produce harvesting device 800 to be operated in a continuous manner. As such, it is not necessary to stop the produce harvesting device 800 at individual plants. In some aspects of the disclosure, the rotational speed of the main body 810 can selected to be greater than or less than the linear velocity of the produce harvesting device 800 to allow for selective control of the impact force of the rods 814 with the tree limbs.

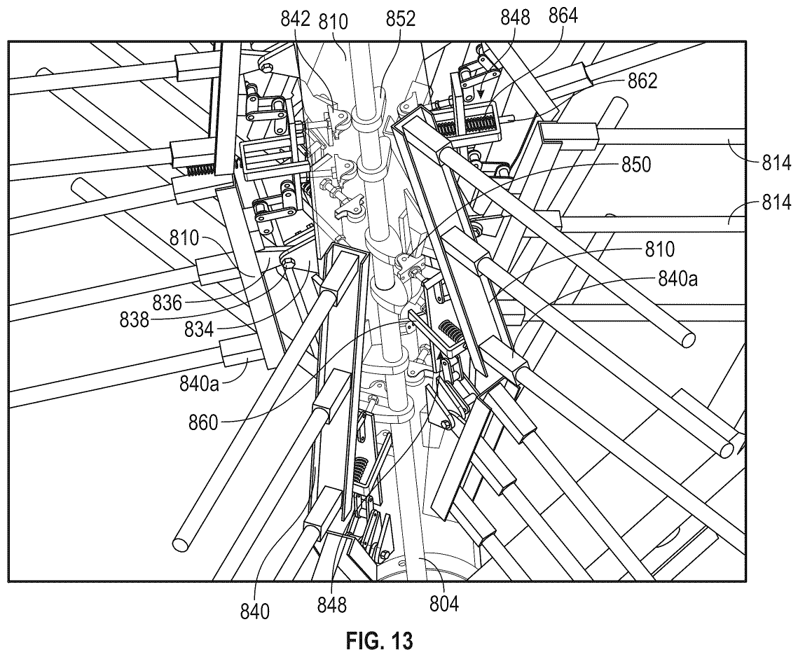

The receivers 812 are pivotably supported on the main body 810. In aspects of the disclosure, the main body 810 supports brackets 834 and each of the receivers 812 includes a flange 836 that is pivotably coupled to one of the brackets 834 by a pivot pin 838. Each of the receivers 812 includes a shaft 840 that supports the flange 836 and a plurality of connectors 840a that extend outwardly from the shaft 840. In aspects of the disclosure, each of the connectors 840a defines a bore 841 (FIG. 13) that receives one end of one of the rods 814 to secure the rods 814 to the receiver 812. Alternately, other coupling devices or techniques can be used to couple the rods 814 to the receivers 812. Although the rods 814 are shown to have a rectangular or square configuration, it is envisioned that the rods 814 can have a variety of different cross-sectional configurations, e.g., circular, square, rectangular, trapezoidal, etc. It is also envisioned that the rods 841 can have different lengths or the same length, and the length or lengths of the rods 841 can be longer or shorter than shown.

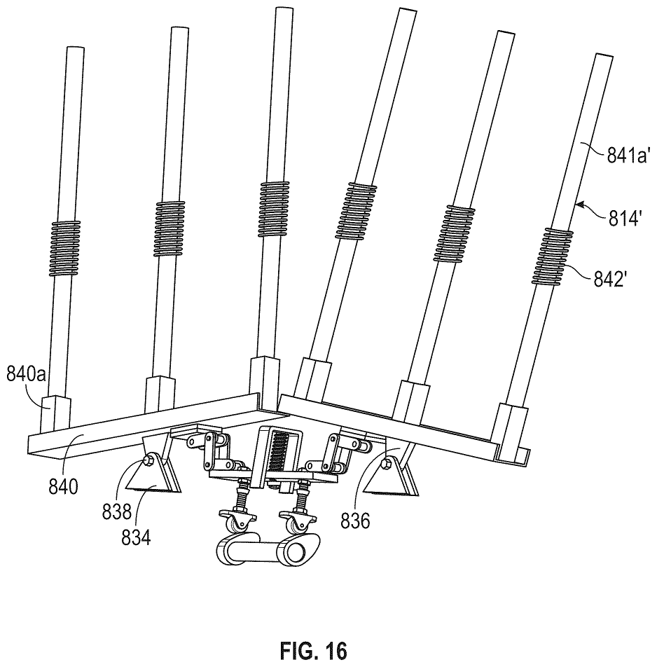

FIG. 16 illustrates an alternate version of the rods 814 shown as rods 814'. The rods 814′ are similar to the rods 814 (FIG. 8) but also include a spring portion 842′. The spring portion 842′ allows the distal portion 841a′ of the rods 814′ to whip back and forth as the rods 814′ engage and disengage a tree canopy to more efficiently disengage the produce from the limbs of a tree.

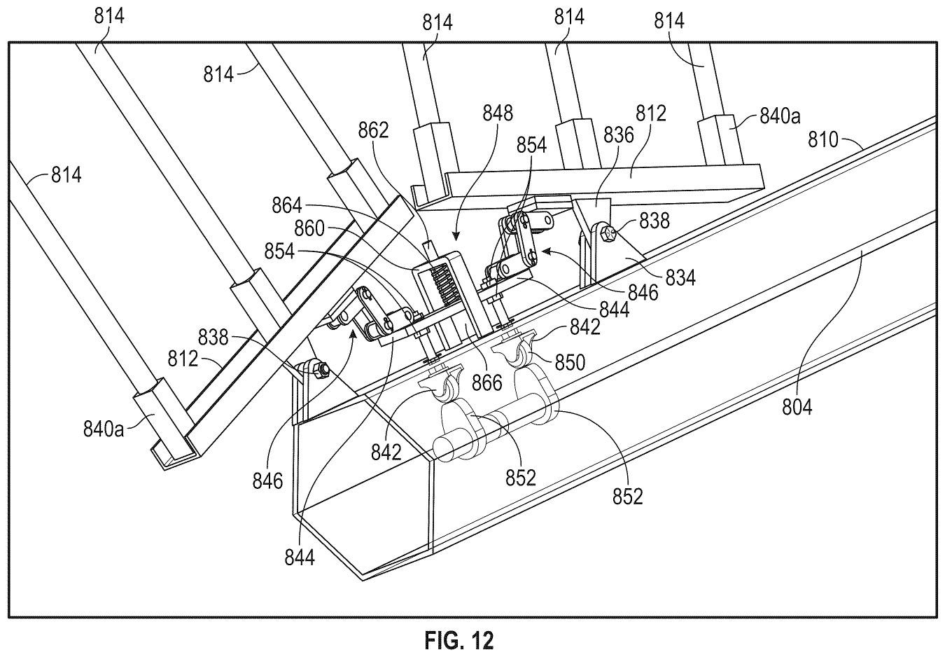

Each of the lifter mechanisms 816 (FIG. 12) is supported on the main body 810 of the produce harvesting device 800 and includes spaced followers 842, a plate 844, links 846, and a biasing mechanism 848. Each of the followers 842 has a first end secured to the plate 844 and a second end supporting a roller 850. In aspects of the disclosure, the first end of each of the followers 842 is threaded and is secured to plate 844 with nuts 854. Alternately, other coupling devices or techniques can be used to secure the first ends of the followers to the plate 844. The camshaft 804 supports a plurality of cam members 852 that are eccentrically configured and engaged with the rollers 850 of the followers 842. When the camshaft 804 is rotated by the second motor 808, the cam members 852 move the followers 842 upwardly and downwardly in reciprocating fashion.

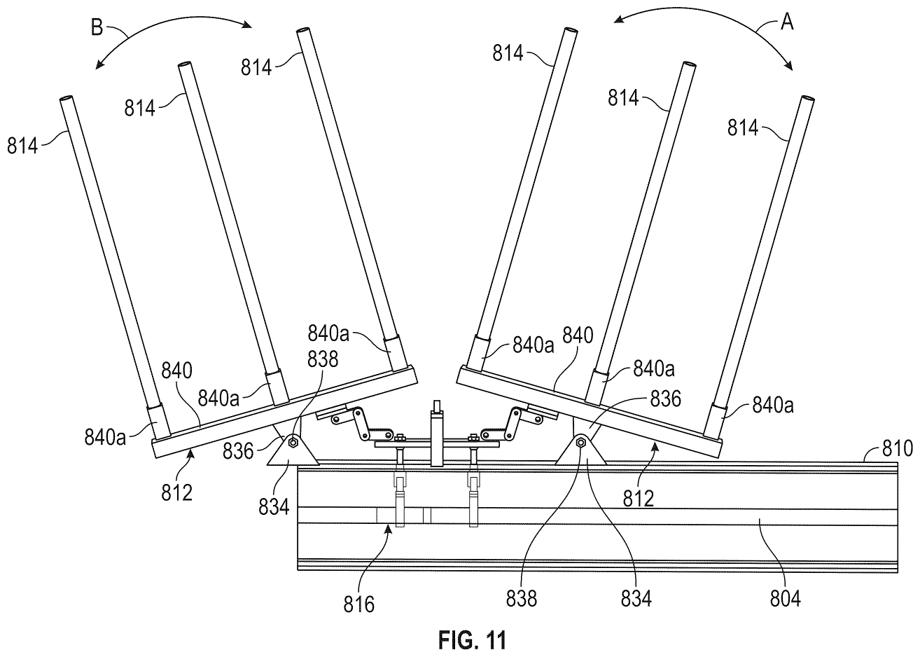

Each of the links 846 has a first end pivotably coupled to the plate 844 and a second end pivotably coupled to one of the receivers 812. In aspects of the disclosure, the links 846 are pivotably supported to the plate 844 at positions spaced longitudinally from the pivot pins 838 coupling the receiver 812 to the main body 810. When the plate 844 reciprocates upwardly and downwardly, the receivers 812 are pivoted about axes defined by the pivot pins 838 to pivot the rods 814 back and forth in reciprocating fashion in the direction indicated by arrows “B” and “C” in FIG. 11.

The biasing mechanism 848 is supported on the main body 810 of the produce harvesting device 800 and includes a bracket 860, an alignment shaft or guide member 862, and a biasing member 864. The bracket 860 may have a generally U-shape or any other suitable shape and is secured to the main body 810 to define an enclosed recess 866. The alignment shaft or guide member 862 is positioned within the recess 866 and has a first end that is secured to the plate 844 between the followers 842 and a second end that extends through an opening defined in the bracket 860. The biasing member 864 is positioned about the alignment shaft or guide member 862 between the bracket 860 and the plate 844 and urges the plate 844 downwardly towards the camshaft 804 to maintain contact between the followers 842 and the cam members 852 of the camshaft 804. In aspects of the disclosure, the biasing member 864 includes a coil spring although the use of other types of biasing members is envisioned.

In use, the produce harvesting device 800 is coupled to a vehicle, e.g., vehicle 102 (FIG. 1A) and advanced along a row of plants at a linear speed with the rods 814 of the produce harvesting device 800 engaged with the canopy of the trees. The main body 810 of the produce harvesting device 800 is rotated by the first motor 806 at a rotational speed that may be congruent to or different from the linear speed of the vehicle such that the relative speed of the rods 814 and the tree canopy is substantially zero. Simultaneously, the camshaft 804 is driven by the second motor 808 to activate the lifter mechanisms 816 to cause the receivers 812 and the rods 814 to oscillate back and forth within the tree canopy to dislodge produce from the tree canopies.

In some aspects of the disclosure, the first motor 806 is coupled to a speed sensor (not shown) of the vehicle 102 by a controller 890 that is operable to control the speed of the first motor 806 in relation to speed of the vehicle 102 to selectively the control the impact of the rods 814 on tree limbs as described above.

Persons skilled in the art will understand that the devices and methods specifically described herein and illustrated in the accompanying drawings are non-limiting exemplary aspects of the disclosure. It is envisioned that the elements and features illustrated or described in connection with one exemplary embodiment may be combined with the elements and features of another without departing from the scope of the disclosure. Also, one skilled in the art will appreciate further features and advantages of the disclosure based on the above-described aspects of the disclosure. Accordingly, the disclosure is not to be limited by what has been particularly shown and described, except as indicated by the appended claims.

What is claimed is:

1. A produce harvesting device comprising:
a chassis having an upper arm, a lower arm, and an intermediate arm connecting the upper arm to the lower arm;
an upper dampener and a lower dampener, the upper dampener supported on the upper arm of the chassis and the lower dampener supported on the lower arm of the chassis;
a main body rotatably supported between the upper arm of the chassis and the lower arm of the chassis;
a camshaft defining a longitudinal axis and extending through the main body between the upper arm of the chassis and the lower arm of the chassis, the camshaft including cam members and being rotatable about the longitudinal axis independently of the main body;
a first motor supported by the chassis, the first motor coupled to the main body to rotate the main body in relation to the camshaft;
a second motor supported by the chassis, the second motor coupled to the camshaft to rotate the camshaft about the longitudinal axis; and
at least one receiver pivotably supported on the main body about a pivot member, the at least one receiver supporting at least one rod, the camshaft operably coupled with the at least one receiver to pivot the at least one receiver in relation to the main body.

2. The produce harvesting device of claim 1, wherein the main body is supported about the camshaft and is rotatable about the longitudinal axis.

3. The produce harvesting device of claim 1, wherein the at least one receiver includes a plurality of receivers and the at least one rod includes a plurality of rods.

4. The produce harvesting device of claim 1, wherein each receiver of the at least one receiver defines a bore and each rod of the at least one rod is received in the bore to couple the at least one rod to the at least one receiver.

5. The produce harvesting device of claim 1, wherein each rod of the at least one rod has a cross-sectional configuration selected from the group consisting of circular, square, trapezoidal, and rectangular.

6. The produce harvesting device of claim 1, further including a controller coupled to the first motor and adapted to be connected to a speed sensor of a vehicle, the controller operable to control the speed of the first motor based upon the speed of the vehicle.

7. The produce harvesting device of claim 6, wherein the controller is operable to control the speed of the first motor to provide a rotational speed of the main body that is congruent to, greater than, or less than a linear speed of the vehicle.

8. The produce harvesting device of claim 1, further including a lifter mechanism including followers, a plate, and links, the followers having a first end engaged with the cam members of the camshaft and a second end secured to the plate, the links having first ends pivotably coupled to the plate and second ends pivotably coupled to the receivers, wherein rotation of the camshaft causes the plate to move reciprocally upwardly and downwardly to cause the receiver to oscillate back and forth about an axis defined by the pivot member.

9. The produce harvesting device of claim 8, wherein the lifter mechanism includes a biasing mechanism, the biasing mechanism including a bracket, a guide member, and a biasing member.

10. The produce harvesting device of claim 9, wherein the biasing member is positioned between the bracket and the plate to urge the followers into engagement with the cam members.

11. The produce harvesting device of claim 10, wherein the at least one rod includes spring portion positioned to allow a distal portion the at least one rods to whip back and forth the as the at least one rod engages and disengages a tree canopy.

12. The produce harvesting device of claim 11, wherein the biasing member includes a coil spring that is positioned about the guide member.

13. The produce harvester of claim 1, wherein the upper dampener and the lower dampener are selected from the group consisting of vibration absorbers, rubber mounts, vibration isolators, air springs, and helical isolators.

14. A produce harvesting device comprising:
a chassis having an upper arm, a lower arm, and an intermediate arm connecting the upper arm to the lower arm;
a main body rotatably supported between the upper arm of the chassis and the lower arm of the chassis;
a camshaft defining a longitudinal axis and extending through the main body between the upper arm of the chassis and the lower arm of the chassis, the camshaft including cam members and being rotatable about the longitudinal axis independently of the main body;
a first motor supported by the chassis, the first motor coupled to the main body to rotate the main body in relation to the camshaft;
a second motor supported by the chassis, the second motor coupled to the camshaft to rotate the camshaft about the longitudinal axis;
at least one receiver pivotably supported on the main body about a pivot member, the at least one receiver supporting at least one rod, the camshaft operably coupled with the at least one receiver to pivot the at least one receiver in relation to the main body; and
a controller coupled to the first motor and operable to control the speed of the first motor based upon the speed of the vehicle.

15. The produce harvesting device of claim 14, wherein the main body is supported about the camshaft and is rotatable about the longitudinal axis.

16. The produce harvesting device of claim 14, wherein the at least one receiver includes a plurality of receivers and the at least one rod includes a plurality of rods.

17. The produce harvesting device of claim 14, wherein the controller is operable to control the speed of the first motor to provide a rotational speed of the main body that is congruent to, greater than, or less than, a linear speed of the vehicle.

18. The produce harvesting device of claim 14, further including a lifter mechanism including followers, a plate, and links, the followers having a first end engaged with the cam members of the camshaft and a second end secured to the plate, the links having first ends pivotably coupled to the plate and second ends pivotably coupled to the receivers, wherein rotation of the camshaft causes the plate to move reciprocally upwardly and downwardly to cause the receiver to oscillate back and forth about an axis defined by the pivot member.

19. The produce harvesting device of claim 18, wherein the lifter mechanism includes a biasing mechanism, the biasing mechanism including a bracket, a guide member, and a biasing member, the biasing member positioned between the bracket and the plate to urge the followers into engagement with the cam members.

20. The produce harvesting device of claim 14, further including an upper dampener and a lower dampener, the upper dampener supported on the upper arm of the chassis and the lower dampener supported on the lower arm of the chassis.
